(19) United States
(12) Patent Application Publication
(10) Pub. No.: US 2008/0138486 A1
(43) Pub. Date: Jun. 12, 2008

(54) Particulate frozen food product

(76) Inventor: Stan Jones, Vienna, IL (US)

Correspondence Address: STOCKWELL & SMEDLEY, PSC, 861 CORPORATE DRIVE, SUITE 200, LEXINGTON, KY, 40503, US

(21) Appl. No.: 11/801,049

(22) Filed: May 8, 2007

Related U.S. Application Data
(63) Continuation-in-part of application No. 11/701,624, filed on Feb. 2, 2007.
(60) Provisional application No. 60/874,055, filed on Dec. 11, 2006.

(51) Int. Cl. A23G 9/00; A23G 9/04

(52) U.S. Cl. 426/565

(57) ABSTRACT

Particulate frozen food products exhibiting properties that allow the particles to remain free-flowing when stored in a typical retail grocery or home freezing environment are disclosed. Preferred embodiments include dairy-based products.

### CROSS-REFERENCE TO RELATED APPLICATIONS

This application is a Continuation-in-Part of U.S. Utility application Ser. No. 11/701,624, which was filed on Feb. 2, 2007, which in turn claims priority to U.S. Provisional Application No. 60/874,055, which was filed on Dec. 11, 2006.

### FIELD OF THE INVENTION

The present invention relates to particulate frozen food product or frozen confection, and in preferred embodiments to particulate ice creams, ice milks, sorbets, and ices capable of being stored within commercial dairy freezers and storage equipment at conventional (non-cryogenic) freezer temperatures.

### BACKGROUND OF THE INVENTION

Recent developments in cryogenics have enabled the manufacture of ice cream-type food products in particulate form using cryogenic equipment. Storing particulate ice cream-type products made using cryogenic techniques usually requires that specialized equipment such as very low temperature freezers, be used for storage and in the retail environment. This is because some particulate products require storage temperatures at or below −35° F. to maintain their free-flowing particulate properties. Such specialized equipment is not present in most food retail establishments, schools, and homes, such that a particulate food product which can be stored in typical retail dairy case and home storage environments is desired.

### SUMMARY OF THE INVENTION

In accordance with a preferred embodiment, there is provided a frozen food product, comprising water and total solids, wherein the food product comprises 6-14% by weight milk fat, 4-24% by weight non-fat milk solids, and 2.6-8% by weight sugar. In preferred products the product is in the form of particulate shapes which remain free-flowing when stored in a freezer at 0° F. for at least 20 days. In certain embodiments, the food product further comprises one or more of the following: 0.1-0.4% by weight sweetener; 1-20% by weight bulking agent; 0.1-1% by weight of cryoprotectant; one or more natural and/or artificial flavors; and 1-4% combined stabilizer/emulsifier. In certain embodiments, the product comprises at least about 29% by weight total solids and less than about 71% by weight water; the product remains free flowing for at least 30 days when stored in a freezer at 0° F., and/or the formulation has a minimum glass transition of at least −53° F., and a devitrification temperature (if present) of at least −52° F. Preferred bulking agents include, but are not limited to, maltodextrins.

In accordance with an embodiment, there is provided a preferably non-dairy frozen food product. The food product comprises water and solids, and comprises 2-10% by weight sugar, 0.01-1.0% by weight sweetener, and 0-2% by weight stabilizer.

In accordance with another embodiment, there is provided a method of manufacturing a frozen food product, comprising preparing a formulation, including one as described above, wherein the formulation is preferably made by combining liquid ingredients, combining dry powders, and mixing the combined dry powders with the combined liquids to make the formulation, and where the method continues by agitating the formulation, pasteurizing the formulation, homogenizing the formulation, aging the formulation, and dripping the formulation into a cryogenic processor to form a particulate frozen food product. In a preferred embodiment, the homogenizing step acts to synchronize the pasteurizing step.

In accordance with another embodiment, there is provided a method of retailing a frozen product, comprising manufacturing a frozen product, including one as described above, shipping the frozen product to a plurality of staging areas, during the shipping step, maintaining the frozen product at a predetermined temperature range, thereby preserving the free-flowing nature of the frozen product, staging the frozen product in strategic storage locations, crossing the frozen product over an international border, shipping the frozen product to a plurality of retail areas, and retailing the frozen product. In a preferred embodiment, the method also includes packaging the frozen product, using gas- or moisture-barrier plastics.

### BRIEF DESCRIPTION OF THE DRAWINGS

FIG. 1 is a flowchart showing details of a preferred embodiment;

FIGS. 2A-2C show distribution mechanisms according to a preferred embodiment;

FIG. 3 shows an equipment arrangement of a preferred embodiment;

FIG. 4 is a cross-sectional elevational view of an apparatus used within a preferred embodiment;

FIG. 5 shows a chart showing the effect of annealing on the thermal behavior of the embodiments during heating;

FIG. 6 presents melting curves of four different formulations obtained in calorimetry testing;

FIG. 7 is an enlargement of the portion of FIG. 6 between −60° C. and −10° C. illustrating the glass transitions and onset of melting for each of the formulations tested;

FIG. 8 is an enlargement of a portion related to the graph of FIG. 6 between −5° C. and +2° C. illustrating freezing points of the formulations tested;

FIG. 9 shows an embodiment in a serving format; and

FIGS. 10 and 11 show another embodiment both individually as well as in a serving format.

### DETAILED DESCRIPTION OF THE PREFERRED EMBODIMENTS

### A. Definitions and General Descriptions

Before explaining the disclosed embodiments in detail, it is to be understood that the invention is not limited in its application to the details of the particular arrangement or formulations shown. Also, the terminology used herein is for the purpose of description and not of limitation.

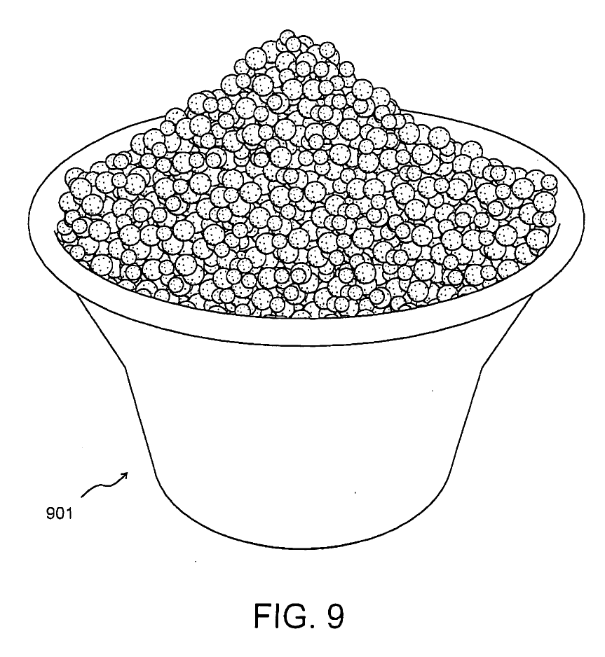

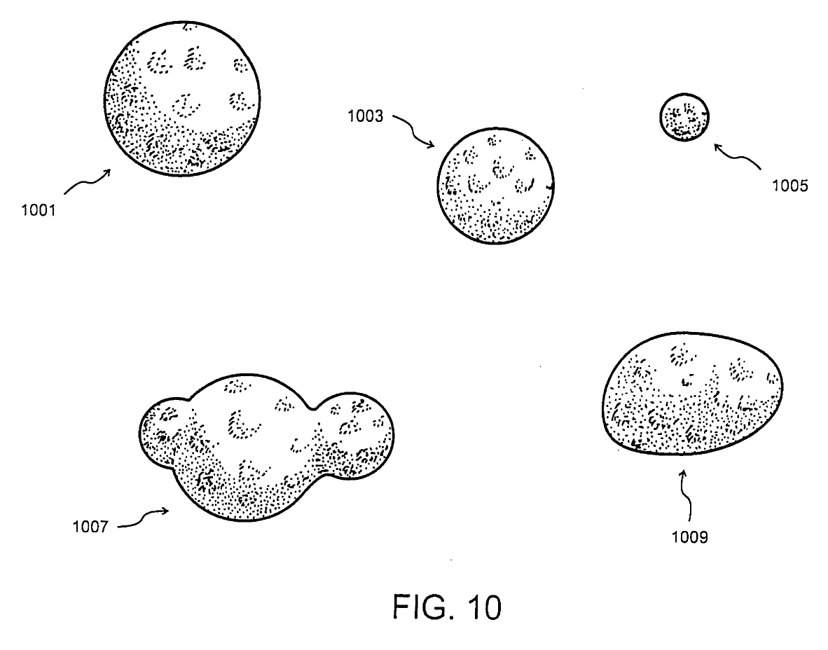

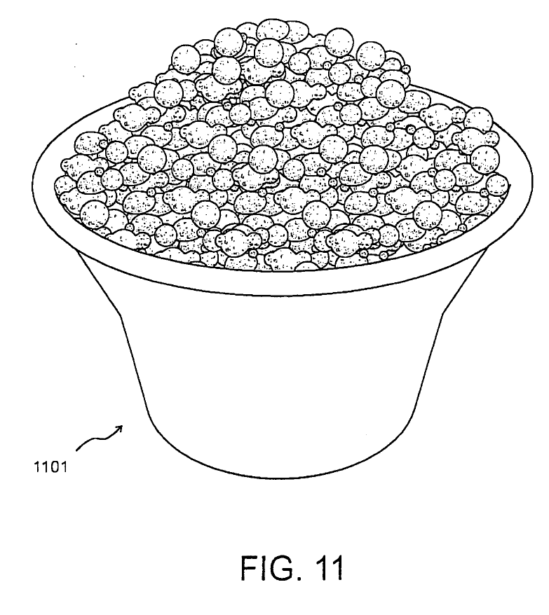

In accordance with preferred embodiments, there are provided formulations of frozen confections, such as ice cream, ice milk, ices, or sorbet, in the form of small particulate shapes. The particulate shapes may have a generally spherical, spheroid shape as shown in FIG. 9, but may also have an oblong, elliptical, oblate, tubular, or other slightly irregular shape as shown in FIGS. 10 and 11. In addition to having an irregular overall shape, the surface of the particulate shape may also be either smooth or irregular (e.g. bumpy, pocked, etc.). On average, the particulate shapes will preferably have a diameter of about 0.05 inch to about 0.5 inch or less, including 0.4 inch, 0.3 inch, 0.25 inch, 0.2 inch, 0.15 inch, and about 0.1 inch, and ranges including and bordered by these dimensions. Particulate shapes having diameters outside these ranges are also contemplated. For non-spherical shapes which do not have a conventional diameter, the diameter is to be the diameter of the smallest sphere into which the particulate shape would fit.

It is desired that the beaded product is in a free-flowing format so that it is readily pourable. Free-flowing, as used herein, is a broad term which includes the ability of the product to flow as individual particulate shapes, with little or no clumping or sticking to each other, during such pouring. There may be slight sticking after a period of storage, but a light tap on the container will unstick the particulate shapes and allow them to be free flowing. The generally spherical shape helps contribute to the free-flowing, pourable product.

Some types of particulate shapes are stored in a specialized, low temperature freezer preferably having a temperature averaging from about −20° F. to about −40° F. In preferred embodiments, particulate shapes that can be stored at higher temperatures, such as in a home freezer or in a grocery dairy freezer are provided, such particulate shapes being able to maintain a free-flowing form while being stored at a temperature between about −10° F. and 0° F. with an occasional rise to perhaps as much as +5° F. One way to accomplish this is to increase the freezing point (reduce the freeze-point depression) of the liquid formulation that forms the particulate shapes, although other ways may also be used. Unless stated otherwise, all percentages recited in this application are percentages by weight of the formulation.

### B. Ingredients and Formulations According to Certain Preferred Embodiments

As stated, it is desired to store the particulate shapes within a conventional freezer and yet still maintain their free-flowing properties. To achieve this, various sample liquid formulations used in making the particulate shapes will now be described. It should be noted that the formulations described below are only examples, and numerous other formulations containing various amounts of ingredients as described herein may be made. Some of the components of three different example formulation types are as follows (all percentages are by weight of the total formulation):

| Ingredient | Formulation I | Formulation II | Formulation III |
|---|---|---|---|
| Milk fat (butterfat) | 9–11% | 6–14% | |
| Non-fat milk solids | 4–12% | 4–20% | |
| Maltodextrins (or other | 0–20% | 0–20% | 0–10% |
| bulking agent) | | | |
| Sugar | 15–17% | 2.6–8% | 2–10% |
| sweetener (artificial) | | <0.4% | <0.8% |
| combined | <1% | <4% | <1% |
| stabilizer/emulsifier | (if present) | (if present) | (stabilizer only) |
| total solids | >=35.5% | >=29.7% | |
| Water | <=63.5% | <=70.3% | 70–96% |

The freezing point of the various formulations disclosed herein which form the particulate shapes can be increased by making adjustments to one or more of the above components, and some adjustments work better in combination with each other. As shown above, some of the formulations above comprise various total solids combined with water. Within the particulate shapes, water is present both as a liquid and as a solid. This is because not all water freezes, due to the presence of dissolved solutes and the cryogenic freezing itself. The solid/liquid ratio within the particulate shapes affects their firmness. This in turn affects pourability and the ability of the particulate shapes to remain free-flowing. Other factors may affect the pourability, including, but not limited to, size of the ice crystals, freezing point, melting point, glass transition temperature, presence or absence of devitrification, storage temperature and conditions. These factors will be discussed further in Section C below.

In the United States, the total solids content must be 35.55% to legally describe a product as ice cream. Accordingly, formulations according to formulation I are considered ice creams in the U.S. This is because most ice creams finished ice cream product must weight at least 4.5 lb/gal and must contain at least 1.6 lb of food solids or total solids per gallon, which essentially equates to a minimum total food solids of 35.5%. In the USA, any finished product below these limits cannot be labeled ice cream. However, other countries have different requirements. For example, in several countries other than the U.S. the total solids content of a formulation can be as low as 29.7%, and possibly lower, yet still be labeled ice cream. Accordingly, formulations according to Formulation II preferably have solids at a level that is considered ice cream in jurisdictions outside the U.S. Therefore, in certain preferred embodiments, the total solids in a frozen confection is at least about 25%, at least about 26%, at least about 26.5%, at least about 27%, at least about 27.5%, at least about 28%, at least about 28.5%, at least about 29%, at least about 30%, at least about 31%, at least about 32%, at least about 33%, at least about 34%, at least about 35%, at least about 36%, or at least about 37%, wherein stated percentages are by weight of the weight of the total formulation including water.

One component of the solids of dairy formulations such as those according to Formulae I and II is milkfat. The milkfat, also called butterfat, in the composition provides much of the creamy texture and body to the formulation, with higher levels providing greater creaminess and richness.

Serum solids or nonfat milk solids are those components of milk and/or cream which are water soluble, including but not limited to caseins and other milk proteins. It is to be noted that although milkfat and water are listed as separate ingredients, milkfat, water and serum solids are, in most embodiments, included in the milks and creams that form the basis of the dairy Formulations I and II, and thus do not necessarily comprise separate ingredients.

Nonfat milk solids enhance the texture of ice cream, aid in giving body and chew resistance, and may be less expensive than milkfat. Whey solids, including modified whey products, may also be substituted for nonfat milk solids but, under USA federal government requirements, not for more than 25% of the total nonfat milk solids in the overall formulation. Egg yolk can also be used as another source of solids. Accordingly, in one embodiment, preferably about 1% to 25%, including 5% to 20% and 10% to 15% of the nonfat milk solids in a formulation comprise whey solids and/or egg yolk solids.

Emulsifiers can also be included within the various formulations, especially those containing milkfat. Preferred emulsifiers can include monoglycerides, diglycerides, and polysorbates. Stabilizers may be included within the various formulations. Stabilizers assist in controlling the viscosity of the formulations, with more stabilizer generally providing increased viscosity, especially in those embodiments having lower amounts of fats and solids. The viscosity affects the drip rate of the formulation while it is formed. Within the dairy Formulations I and II, preferred stabilizers can include guar, carrageenan, LBG, and/or CMC. Within the non-dairy Formulation III, a preferred stabilizer can include cellulose gum.

In those dairy embodiments where both stabilizers and emulsifiers are used, the formulations disclosed herein for making the frozen confection includes a combined stabilizer/emulsifier, and the recited amounts are the combined total of the stabilizer and emulsifier present. The combined stabilizer/emulsifier need not actually be added as a single ingredient when making the formulation; the weights of these two materials are included together because in many embodiments, commercial combined stabilizer/emulsifier formulations are used, which include one or more stabilizers and one or more emulsifiers. Accordingly, the stabilizer/emulsifier may be a commercial or proprietary formulation or it may be a combination or series of one or more stabilizers and/or one or more emulsifiers added to the formulation.

One or more bulking agents may also be added to formulations according to certain embodiments. Bulking agents include high molecular weight polymeric compounds (such as polysaccharides), which add viscosity and bulk to foods. Preferred bulking agents include, but are not limited to polydextrose, dextrans, corn syrup solids, and maltodextrins. In certain preferred embodiments, maltodextrins are used, including, but not limited to, those having a DE of 5, 10, 15, and 20, where DE refers to “dextrose equivalent”. In a preferred embodiment, the total amount of bulking agents is 1% to 20% by weight, including 1%-15% by weight, 5%-15% by weight, including 6%, 8%, 10% and 12% by weight. Because bulking agents and stabilizers both contribute to the viscosity of a formulation, formulations containing a bulking agent may or may not include a stabilizer or stabilizer/emulsifier.

Formulations preferably include at least some sugar (sucrose). Sucrose is preferably present at 2-17% by weight, including 2-8%, 10-17%, 5-15%, about 3%, 4%, 5%, 6%, 7%, 8%, 9%, 10%, 11%, 12%, and 13% and ranges encompassing and bounded by these values. Formulations generally also include some lactose, as it is a natural part of milk, cream, and nonfat milk solids. In a preferred embodiment, the lactose in the formulation is at 2-15% by weight, including 2-8%, 5-10%, 5-15%, about 3%, 4%, 5%, 6%, 7%, 8%, 9%, 10%, 11%, 12%, and 13% and ranges encompassing and bounded by these values. Formulations may include other non-sugar sweeteners in the formulation such as fructose, sugar alcohols also known as polyols, such as erythritol, xylitol, and maltitol, artificial sweeteners including, but not limited to, sucralose, aspartame, and saccharine, and combinations of one or more sweeteners. Because artificial sweeteners are much sweeter than sugar for a given weight, for example, sucralose is about 600 times sweeter than sugar, the amount of sucralose can be very small (e.g. 0.01-0.4% by weight, if present, including about 0.015, 0.02, 0.03, 0.04, 0.05, 0.1, 0.15, 0.2, 0.3 and ranges encompassing and bounded by these values) yet still have effective sweetness. Accordingly, the substitution of artificial sweeteners for sugar can reduce the amount of solids and sucrose in the formulation.

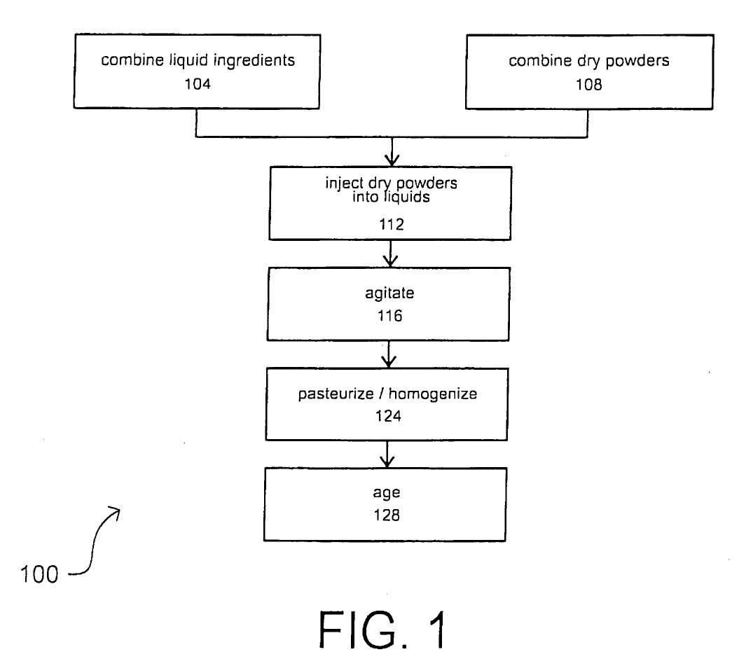

Of the artificial sweeteners, sucralose has an advantage of remaining stable during homogenization/pasteurization (step 124 of FIG. 1). Sucralose is not used to give bulk volume to the resulting formulation, as doing so would make the resulting formulation excessively sweet. Other non-sugar sweeteners have some similar properties as well.

The formulations also include one or more flavorings. These include but are not limited to chocolate, strawberry, vanilla, and banana split. The amount of flavoring added is usually somewhat small, such that differences in composition are relatively minute such that the flavoring does not substantially affect the storability characteristics of the particulate shapes formed from the various formulations.

It should be noted, however, that some flavorings, such as the chocolate generally require the presence of additional sweeteners over what is necessary for other flavorings (e.g. vanilla). In the case of chocolate, additional sugar or sweetener such as corn syrup solids or other sweetener are preferably added in excess of the amount that would be present normally to provide additional sweetness that is of benefit with the cocoa powder added for flavoring at a level, in preferred embodiments, of about 0.5%-2%, including about 1% and 1.5%.

As shown above, a variety of formulations are available which fall within the parameters disclosed herein. However, within all formulations including a solids component (generally the dairy-based formulations) the total solids percentage plus water percentage will equal 100. Thus, for example, if the total solids content of a formulation rises, it is to be understood that the water content is reduced accordingly.

For formulations according to Formulation I, the milkfat content is preferably about 9-11%, including about 9.5%, 10%, and 10.5% and ranges encompassing and bounded by these values; the nonfat milk solids content is preferably about 8-12%, including about 4.5%, 5%, and 5.5% and ranges encompassing and bounded by these values; the sugar content is preferably about 15-17%, including about 15.5%, 16%, and 16.5% and ranges encompassing and bounded by these values; the stabilizer/emulsifier content is preferably 0.1-1%, including about 0.5%; and the serum solids content is preferably 4-6%, including about 4.5%, 5%, and 5.5% and ranges encompassing and bounded by these values. Although non-sugar sweeteners are frequently not present, in some embodiments they may be present at levels of about 0.01-0.5%. In one preferred embodiment according to Formulation I, the milk fat (butterfat) content is approximately 10.5%, the sucrose (sugar) is approximately 16%, the non-fat milk solids are approximately 5.1%, the stabilizer/emulsifier is approximately 0.3%, and the serum solids are approximately 5.1%, thereby resulting in total solids of approximately 36.0% with the remainder of the formulation (about 64.0%) being water, wherein all stated percentages are by weight. The percentages stated above are preferred values, and formulations having percentages outside these values and including one or more other ingredients are also contemplated.

For formulations according to Formulation II, the milkfat content is preferably about 6-14%, including about 8-12%, and 7%, 9%, 10%, 11%, and 13% and ranges encompassing and bounded by these values; the nonfat milk solids content is preferably about 4-24%, including about 13-16%, including about 5%, 6%, 7%, 8%, 9%, 10%, 11%, 12%, 14% and 15% and ranges encompassing and bounded by these values; the sugar content is preferably about 2-5%, including about 2.5%, 3%, 3.5%, 4% and 4.5% and ranges encompassing and bounded by these values; the total content of one or more non-sugar or artificial sweeteners is preferably about 0.01-01%, including about 0.1-0.5% and 0.05%, 0.2%, 0.3%, 0.4%, 0.6%, 0.7%, 0.8% and 0.9% and ranges encompassing and bounded by these values; the stabilizer/emulsifier content is preferably about 0.1-4%, including about 0.1%, 2%, and 3% and ranges encompassing and bounded by these values; and the serum solids content is preferably 4-8%, including about 5%, 6%, and 7% and ranges encompassing and bounded by these values. In one preferred embodiment according to Formulation II, the milkfat is approximately 8.4%; the non-fat milk solids is approximately 13%; the sucrose is approximately 3%; the combined stabilizer/emulsifier is approximately 0.3%, the sucralose is approximately 0.02%; and the serum solids are approximately 5.2%; with the remainder being water. All percentages in this paragraph are by weight.

Non-dairy formulations, such as Formulation III above, are also contemplated. Formulations according to Formulation III, include preferably about 2-10% sugar, including about 3-6%, including about 4%, 5%, 7%, 8%, and 9% and ranges encompassing and bounded by these values; optionally about 0.01-1% non-sugar sweetener, including about 0.05%, 0.2%, 0.3%, 0.4%, 0.6%, 0.7%, 0.8% and 0.9% and ranges encompassing and bounded by these values; and a stabilizer content of preferably 0.1-1%, including about 0.5%, with the remainder being water. One preferred embodiment of the non-dairy Formulation III includes approximately 95% water, approximately 4% sucrose, approximately 0.5% non-sugar sweetener such as sucralose, and approximately 0.8% stabilizer, with the remainder being water. No labeling restrictions exist regarding total solids content, as water-based products do not purport to resemble ice cream.

Within the non-dairy Formulation III, the stabilizers play an important role. Among other functions, they are responsible for absorbing free water sometimes present within the ice product formulation. One stabilizer that can effectively serve this purpose is cellulose gum, although many other stabilizers can be used.

Stabilizing agents are also used to give texture, body, stiffness and alter the melting properties of the ice products described herein. These are especially important in particulate ice product, because forming the particulate shapes in a spherical or similar shape and the resulting free-flowing properties generated therefrom are beneficial to the commercial success of the product. The stabilizers accomplish this by binding up water that has melted due to temperature fluctuations, and thus preventing that water from diffusing throughout the entire formulation and forming larger ice crystals upon refreezing.

### C. Characteristics and Properties of Certain Preferred Embodiments

As noted before, particulate ice cream is generally stored at very low temperatures in cryogenic freezers. In certain preferred embodiments, the product is capable of being stored at higher temperatures, such as in a freezer at temperatures that are commonly used to store conventional ice cream and frozen foods while maintaining the properties of the particulate shapes being substantially free-flowing and pourable. Accordingly, in a preferred embodiment, a formulation of beaded product is substantially free flowing when stored at a temperature between −10° F. and 10° F., including −5° F. and 0° F. with or without including an occasional rise to perhaps as much as +5° F., such product being stored for a period of time of about four months, including about three months, about two months and about one month. Such temperature conditions of storage at 0° F. with a periodic rise to about +5° F. are commonly found in self-defrosting commercial freezers at retail establishments where products, such as frozen confections may be sold. Maintenance of the free-flowing nature of the particulate shapes is highly desired because it has important commercial significance.

Several factors and properties can affect the stability and performance of formulations suitable for storage at higher temperatures. One property is the freezing point of the formulation. Formulations having a higher freezing point are able to remain more firmly frozen at higher freezer temperatures, which contributes positively to the product remaining free-flowing. One way to increase the freeze point of a formulation is to decrease the amount of low molecular weight compounds with or without modifying the total solids of the formulation.

In a preferred embodiment, a formulation has a freezing point of at least 27° F., including at least about 27.5° F., at least about 28° F., at least about 28.5° F., at least about 29° F., at least about 29.5° F., at least about 30° F., at least about 30.5° F., at least about 31° F., and at least about 31.5° F. In a preferred embodiment, the freezing point is between 29° F. and 31° F.

In embodiments having a higher storage temperature partly because of a reduction in solids, one way of improving the palatability of the product is to increase the amount of non-fat milk solids. Non-fat milk solids improve body, texture, and most importantly taste of the resulting particulate shapes.

One way of reducing the solids is to replace sucrose in the formulation with an artificial sweetener that provides high sweetening power but donates much less solids that would contribute to an undesirable depression of the freezing point. It has been found, however, that there is a benefit in retaining some sucrose in a formulation, because it is useful as a body enhancer and shelf life extender, thereby keeping the artificial sweeteners from going flat in taste over time.

Because sugars like sucrose and lactose or small saccharides (e.g. disaccharides) contribute very strongly to freezing point depression, in certain embodiments, the amount of such small saccharides is reduced or minimized. Strategies for reducing the amount of sucrose include substituting other non-sugar or high molecular weight sweeteners. Strategies for reducing the amount of lactose include using reduced-lactose milk, cream and/or alternative nonfat milk solids, and/or using less of one or more of these ingredients. In a preferred embodiment, the total amount of disaccharides in a formulation is preferably 20% by weight or less, including 15% or less, 12% or less, 11% or less, 10% or less, 9% or less, 8% or less, 7% or less, 6% or less, and 5% or less (including ranges encompassing and bounded by these values), and including about 5%-15%, and about 5% to 10%. In a preferred embodiment, monosaccharides and/or disaccharides preferably make up 60% by weight or less of the total nonfat solids in a formulation, including 50% by weight or less, including 40% or less, 35% or less, 33% or less, 30% or less, 25% or less, 20% or less (including ranges encompassing and bounded by these values), including about 25%-45%, and about 30% to 40%. The solids content of the formulation can be maintained by replacing some or all of the eliminated monosaccharides and/or disaccharides with higher molecular weight compounds, for example, bulking agents and other milk solids.

Although not wishing to be bound by theory, it is believed that one of the factors that contributes to sticking of the particles is the amount of free (non-crystalline) water present in the formulation. That is, if two formulations having equal amounts of total water but different proportions of ice to free water (due to differences in formulation) are stored in identical conditions, it is postulated that the formulation having the higher percentage of free water will tend to have particles that stick together more (and sooner) than the formulation having more of its water bound up in crystals as ice. Accordingly, in a preferred embodiment, preferably 0.1% to 16% of the water in a formulation is present as free water at 0° F., including about 5% to 15%, 7%-11%, and 7%, 8%, 9%, 10%, 11%, 12%, 13%, 14%, and 15% and ranges encompassing and bounded by these values.

The amount of free water in a formulation at a given temperature depends upon the temperature of the onset of melting. Therefore, in certain preferred embodiments, the temperature at which the melting of a frozen formulation begins (onset of melting) is preferably about −31° F. or higher, including −30° F. or higher, −25° F. or higher, −20° F. or higher, −15° F. or higher, −10° F. or higher, and −5° F. or higher, including ranges encompassing and bounded by these values, including but not limited to −30° F. to −10° F. and −25° F. to −10° F.

Other properties that affect the properties of the product at higher temperatures are the glass transition and devitrification temperatures of the product formulation. Initially when the beaded product is formed, it is flash frozen such that the product is a food glass in which the molecules of the formulation are in an arrested state of motion such that they cannot organize into a crystalline structure even though the formulation is at a temperature well below the freezing point. This glassy form is characterized by the molecules being disordered and the material is brittle and somewhat unstable. As this material is warmed, it surpasses or goes through its glass transition. This occurs at a temperature preferably around −40° F. (± about 5° F.). At the glass transition temperature, molecules in the formulation begin to break free such that the material transitions from the glassy state into a material that is rubbery or plasticized.

If the material is allowed to continue to warm to a slightly higher temperature, it will eventually reach the temperature at which devitrification might occur. Devitrification is the process of ice formation during heating. With regard to devitrification and ice crystal formation, there are several considerations. Two considerations are the temperature at which devitrification occurs and the magnitude of the exotherm during ice formation.

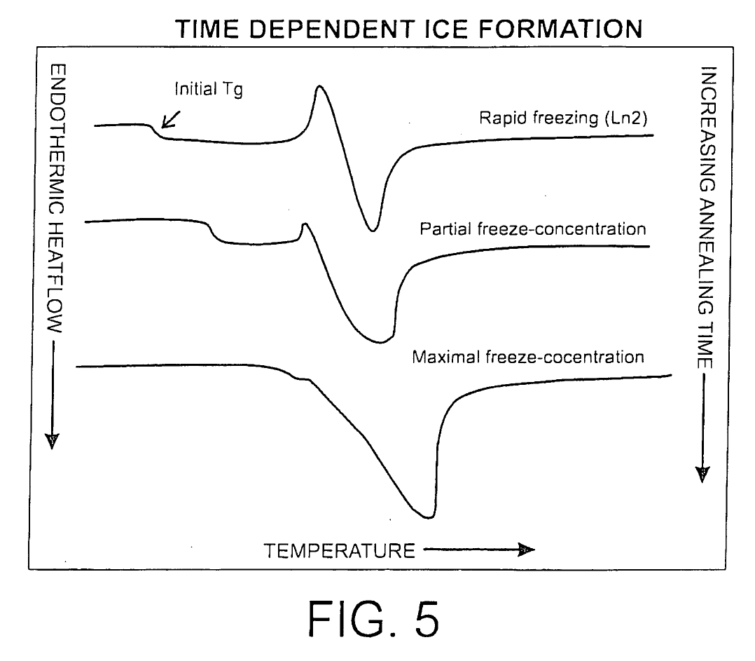

FIG. 5 provides curves showing the effect of annealing upon the behavior of a formulation during heating, including the effect on glass transition, devitrification, and melting. The uppermost curve presents the behavior of a sample that has been quenched in liquid nitrogen and is then heated. This material has a marked devitrification exotherm during which ice formation occurs. As the annealing time is increased, the devitrification exotherm is reduced until it is essentially absent in a formulation that has undergone maximal freeze concentration brought about by a longer annealing period.

Because the rate that stickiness or clumping of the particles occurs is also dependent upon the ability of the water molecules to move freely within the formulation matrix to form crystals, another way of reducing the rate of crystal formation is to create a more viscous formulation matrix. This can be done by reducing the amount of small molecules in a formulation and/or increasing the amount of large molecules in a formulation. For example, the amount of sucrose can be reduced, and/or milk products with reduced lactose can be used. Larger molecules, including but not limited to bulking agents such as maltodextrins, can be added to the formulation.

Many factors and variables may contribute to vitrification/devitrification (transition into/out of glassy state respectively), some of which are sucrose level, protein content and source, stabilizers, maltodextrins, and storage temperature. Accordingly, in certain preferred embodiments the formulation is formulated so as to increase the glass transition temperature and/or minimize or eliminate devitrification. Because the likelihood of the particles of formulation sticking to each other and the loss or reduction of the free-flowing characteristics of the material increases with temperature (and increases at a greater rate at higher temperatures), storing, transporting, and handling the product preferably occurs at a temperature below the onset of melting and/or below or not well above the glass transition temperature to help the product remain free-flowing and help prevent sticking or clumping. In a preferred embodiment, the product is stored at a temperature that is within about 10° F., including about 8° F., 6° F., 5° F., 4° F., 3° F., 2° F., and 1° F. (including ranges encompassing and bounded by these values) of the onset of melting. Storage at such a temperature will allow the product to age properly.

In a preferred embodiment, a formulation has a glass transition temperature (midpoint) of at least −55° F., including at least about −50° F., including at least about −45° F., including at least about −40° F., including at least about −35° F., at least about −30° F., at least about −25° F., at least about −20° F., at least about −15° F., at least about −10° F., at least about −5° F., and at least about 0° F. (including ranges encompassing and bounded by these values).

Another property that affects performance at higher storage temperatures is the ice crystal size. In preferred processes of making the product, as discussed in greater detail below, the formulation is frozen very rapidly, and is sometimes referred to as flash-freezing. The rate at which the droplets of the formulation are frozen into particulate shapes is very rapid, with the complete freezing process being completed within less than two minutes. Because of this, and provided that the formulation is not allowed to be at high temperatures (above the melting point or devitrification point) for extended periods of time, the ice crystals formed therein are much smaller than if the formulation were frozen more slowly. This is a desired feature. Large ice crystals can cause the particulate shapes to be perceived as coarse and less palatable.

Regarding glass transition, the use of maltodextrins or other bulking agents in Formulations I and II and other formulations disclosed herein can be beneficial during the transition from the glass to the rubbery state. This is because maltodextrins inhibit the mobility of unbound (free) water. The less free water there is available to move around, the harder it is for free water to form ice crystals and/or promote product stickiness. Instead, the maltodextrins or other bulking agents help to constrain the free water so that crystal formation is more difficult.

Recrystallization is the process of changes in number, size and shape of ice crystals during frozen storage, although the amount of ice stays constant with constant temperature throughout this process. Recrystallization basically involves small crystals disappearing, large crystals growing, and crystals fusing together.

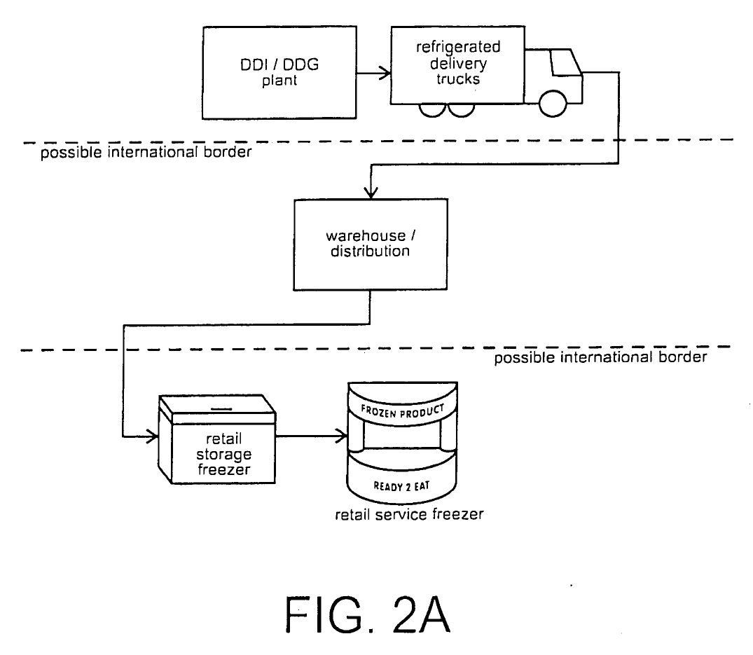

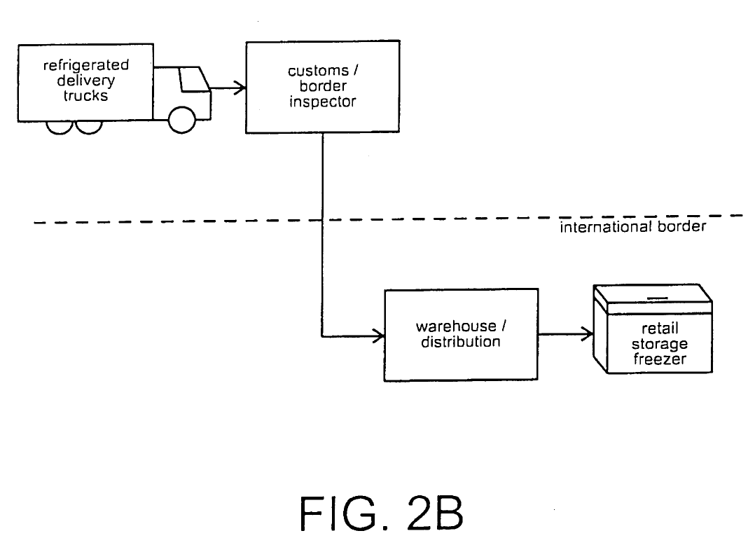

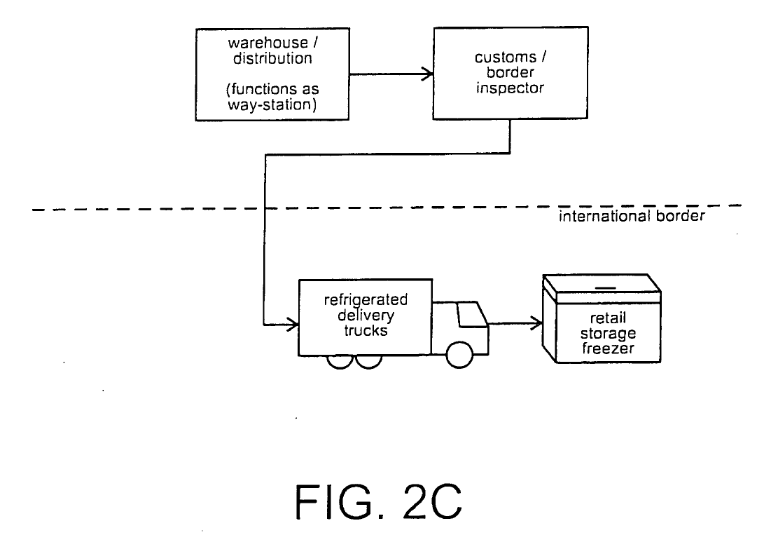

Recrystallization occurs during higher storage temperatures (heat shock) that induce refreezing. Such heat shock could occur during the transporting and storage of the particulate shapes, including during the inspection process which is necessary at international borders for example, as shown in FIGS. 2A-C. Recrystallization is undesirable because it can lead to disappearance of smaller crystals during warming, and growth of larger crystals during later freezing. Smaller crystals are more subject to melting. Thus, even if the products have smaller ice crystals at formation, it is preferable to make them more able to withstand temperature changes during shipping and storage. One way to do this is be careful management of the product during shipping, as shown in FIGS. 2A-C.

Another way to preserve small crystal size and maintain the product during shipping and storage is to include cryoprotectant, including but not limited to ice structure proteins and propylene glycol monostearate, in the formulation. These materials are optionally included in a formulation at about 0.1% to 5% by weight, including 0.1% to 1%, 0.2%-0.6%, and 0.2%-0.4%.

Therefore, although a formulation having the highest freeze point might be considered to have the highest storage temperature, this is not necessarily the case. This is because there are many factors that affect storage stability, such as glass transition, presence or absence of devitrification, amount of free water present at the storage temperature, and/or onset of melting for any given formulation.

Several different properties of formulations have been discussed above in this section. Formulations according to preferred embodiments preferably have at least one of the preferred properties discussed above. It is not required that any or all formulations possess all preferred properties. Preferred properties of a product may vary depending upon any number of variables, including but not limited to the shipping conditions, storage conditions, average time between production and consumption, country of sale, and the like with respect to a given product. The skilled artisan balances the various physical properties and characteristics of a formulation, along with the very important property of taste, to create a formulation that he feels best meets the needs and constraints placed upon the product by virtue of its production, storage, handling, and use. Such formulations may maximize some properties and/or minimize others as part of the trade-offs that are frequently part of the art of formulating a product.

A variety of packaging options may be used to maintain the beaded product in optimum condition after formation. At the higher freezer temperatures (such as 0° F.), moisture is attracted to the product which forms undesirable ice crystals on the product after about 7 days, depending on various conditions. Therefore, it is desired to package the product using materials that will prevent moisture from migrating through to the particulate shapes. Some plastics will allow moisture to penetrate into the package, so it is desired to avoid these. Instead, gas- or moisture-barrier plastics may be used for packaging the particulate shapes. Also, aluminum foil may also be used alone or in combination with plastic and/or paper layers. Other materials are also contemplated within the spirit and scope of this disclosure.

### EXAMPLES

### Example 1

### Formulation A

A dairy-based frozen formulation was made according to the ingredient list below:

| | % by | |
|---|---|---|
| INGREDIENT | weight | Weight (kg) |
| Cream (35% fat) | 28.5 | 0.86 |
| Water | 47.2 | 1.41 |
| Skim milk powder | 8.3 | 0.25 |
| Sucrose | 3.0 | 0.09 |
| Maltodextrin DE10 | 13.0 | 0.39 |
| TOTAL | 100 | 2.99 |

For this formulation, the percentages of water and solids were as follows:

| | | % | | | | |
|---|---|---|---|---|---|---|
| | | nonfat | % | % non- | % | |
| | | milk | su- | disaccharide | total | % |
| INGREDIENTS | % fat | solids | crose | carbohydrates | solids | water |
| TOTAL | 10.1 | 9.2 | 3.0 | 12.4 | 35 | 65 |

The dry ingredients were combined and the liquid ingredients were separately combined. The combined dry ingredients and the combined liquid ingredients were then mixed together until they were well blended and then frozen by immersion in liquid nitrogen for at least about 15 seconds. The formulation contains 5.2% lactose (derived from the cream and skim milk powder components). The total disaccharide content of this formulation is approximately 8.2% by weight, which represents 33% by weight of the total nonfat solids of the formulation.

### Example 2

### Formulation B

A dairy-based frozen formulation was made according to the ingredient list below:

| | % by | |
|---|---|---|
| INGREDIENTS | weight | Weight (kg) |
| Cream (35% fat) | 28.5 | 0.86 |
| Water | 46.6 | 1.40 |
| Skim milk powder | 4.5 | 0.14 |
| Sucrose | 7.0 | 0.21 |
| Maltodextrin DE10 | 13.0 | 0.39 |
| TOTAL | 100 | 3.00 |

For this formulation, the percentages of water and solids were as follows:

| | | % | | | | |
|---|---|---|---|---|---|---|
| | | nonfat | % | % non- | % | |
| | | milk | su- | disaccharide | total | % |
| INGREDIENTS | % fat | solids | crose | carbohydrates | solids | water |
| TOTAL | 10.0 | 5.7 | 3.0 | 12.4 | 35 | 65 |

The dry ingredients were combined and the liquid ingredients were separately combined. The combined dry ingredients and the combined liquid ingredients were then mixed together until they were well blended and then frozen by immersion in liquid nitrogen for at least about 15 seconds. The formulation contains 3.2% lactose (derived from the cream and skim milk powder components). The total disaccharide content of this formulation is approximately 10.2% by weight, which represents 40% by weight of the total nonfat solids of the formulation.

### Example 3

### Formulation C

A dairy-based frozen formulation was made according to the ingredient list below:

| | % by | |
|---|---|---|
| INGREDIENTS | weight | Weight (kg) |
| Milk (3.5% fat) | 57.9 | 1.74 |
| Cream (35% fat) | 15.5 | 0.47 |
| Water | 10.5 | 0.31 |
| Skim milk powder | 13.0 | 0.39 |
| Sucrose | 2.8 | 0.084 |
| Stabilizer/Emulsifier | 0.34 | 0.010 |
| (guar gum/carageenan) | | |
| TOTAL | 100 | 3.0 |

For this formulation, the percentages of water and solids were as follows:

| | | % | | | | |
|---|---|---|---|---|---|---|
| | | nonfat | | | | |
| | | milk | | | % total | % |
| INGREDIENTS | % fat | solids | % S/E | % sucrose | solids | water |
| TOTAL | 8.3 | 18.2 | 0.34 | 2.8 | 30 | 70 |

The dry ingredients were combined and the liquid ingredients were separately combined. The combined dry ingredients and the combined liquid ingredients were then mixed together until they were well blended and then frozen by immersion in liquid nitrogen for at least about 15 seconds. The formulation contains 10.4% lactose (derived from the cream and skim milk powder components). The total disaccharide content of this formulation is approximately 13.2% by weight, which represents 60% by weight of the total nonfat solids of the formulation. This formulation, when made in particulate form such as described below in Section D, Preferred Apparatus and Methods of Manufacture, remained free flowing when stored in a self-defrosting freezer at 0° F. for 6-12 months or longer.

### Example 4

### Formulation D

A dairy-based frozen formulation was made according to the ingredient list below:

| | % by | |
|---|---|---|
| INGREDIENTS | weight | Weight (kg) |
| Milk (3.5% fat) | 49.0 | 1.47 |
| Cream (35% fat) | 22.0 | 0.66 |
| Water | 7.9 | 0.24 |
| Skim milk powder | 4.8 | 0.14 |
| Sucrose | 16.0 | 0.48 |
| Stabilizer/Emulsifier | 0.34 | 0.010 |
| (guar gum/carageenan) | | |
| TOTAL | 100.0 | 3.00 |

For this formulation, the percentages of water and solids were as follows:

| | | % | | | | |
|---|---|---|---|---|---|---|
| | | nonfat | | | | |
| | | milk | | | % total | |
| INGREDIENTS | % fat | solids | % S/E | % sugar | solids | % water |
| TOTAL | 10.6 | 9.9 | 0.34 | 16.0 | 36.8 | 63.2 |

The dry ingredients were combined and the liquid ingredients were separately combined. The combined dry ingredients and the combined liquid ingredients were then mixed together until they were well blended and then frozen by immersion in liquid nitrogen for at least about 15 seconds. The formulation contains 5.6% lactose (derived from the cream and skim milk powder components). The total disaccharide content of this formulation is approximately 21.6% by weight, which represents 80% by weight of the total nonfat solids of the formulation. This formulation, when made in particulate form such as described below in Section D, Preferred Apparatus and Methods of Manufacture, begins to stick when stored in a self-defrosting freezer at 0° F. in about 4-6 hours.

### Example 5

### Formulation E

A dairy-based frozen formulation is made according to the ingredient list below:

| | % by | |
|---|---|---|
| INGREDIENTS | weight | Weight (kg) |
| Milk (3.5% fat) | 57.9 | 1.74 |
| Cream (35% fat) | 15.5 | 0.47 |
| Water | 5.5 | 0.16 |
| Skim milk powder | 13.3 | 0.40 |
| Sucrose | 2.8 | 0.084 |
| Maltodextrin DE10 | 5.0 | 0.15 |
| TOTAL | 100.0 | 3.0 |

For this formulation, the percentages of water and solids are as follows:

| | | % | | | | |
|---|---|---|---|---|---|---|
| | | nonfat | % | % non- | % | |
| | | milk | su- | disaccharide | total | % |
| INGREDIENTS | % fat | solids | crose | carbohydrates | solids | water |
| TOTAL | 8.3 | 18.5 | 2.8 | 4.7 | 34 | 66 |

The dry ingredients are combined and the liquid ingredients are separately combined. The combined dry ingredients and the combined liquid ingredients are then mixed together until they are well blended and then frozen by immersing in liquid nitrogen for at least about 15 seconds. The formulation contains 9.2% lactose (derived from the cream and skim milk powder components). The total disaccharide content of this formulation is approximately 12% by weight, which represents 46% by weight of the total nonfat solids of the formulation.

### Example 6

### Testing of Formulations Using Calorimetry

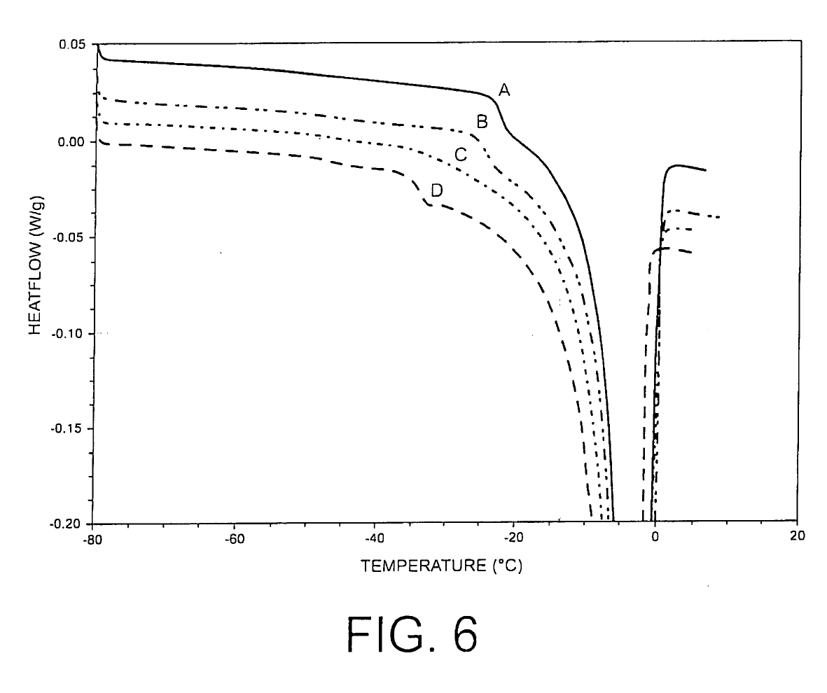

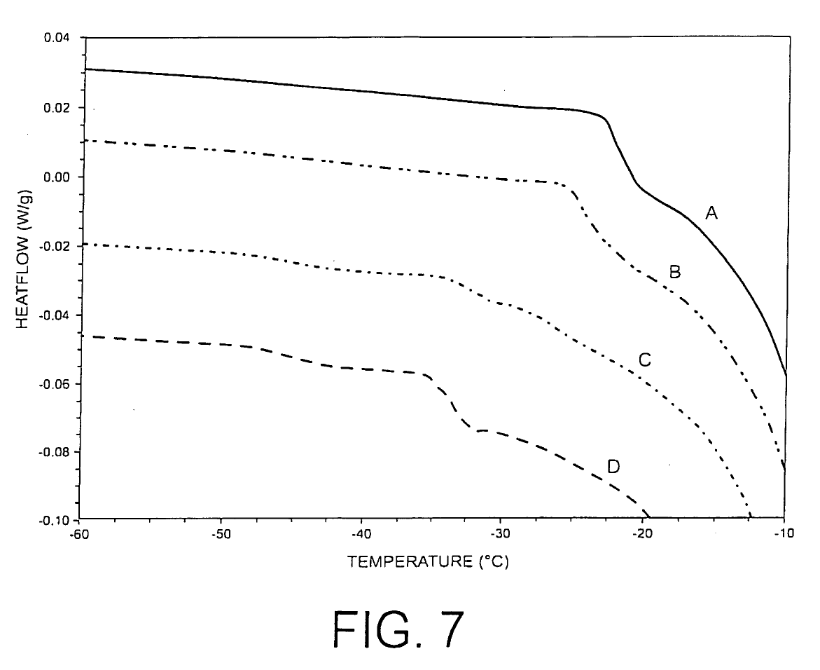

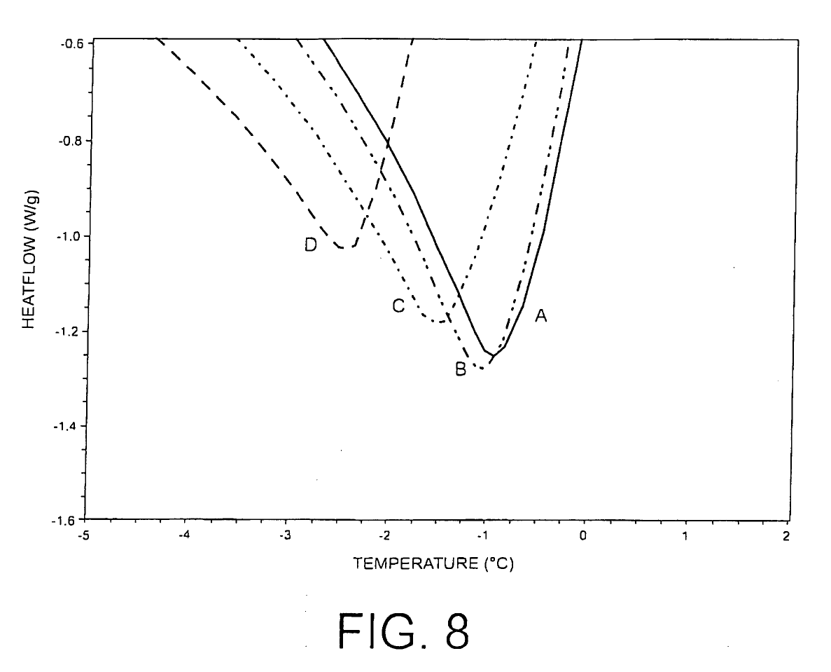

Formulations A, B, C, and D above were tested using calorimetry. Results of testing are presented in FIGS. 6, 7, and 8 and certain data are summarized in the Table 1 below. Freezing point, glass transition, and onset of melting temperatures were measured with a modulated temperature differential scanning calorimeter (DSC, Q1000 TA instrument, New Castle, Del.). The instrument was calibrated using sapphire, gallium (mp 29.8° C.) and indium (mp=156.6° C.). Nitrogen (150 ml/min) was used as a purge gas. Hermetically sealed alod-al pans (TA Instruments) were used, and the sample (ice cream mix) size was about 15 mg.

The temperature protocol was as follows. A sample was placed in the calorimeter and allowed to equilibrate at 5° C. The temperature was then ramped at 5° C./min to −25° C., and then ramped at 10° C./min to −10° C. where the temperature was held for approximately 10 min. The temperature was then ramped at 10° C./min to −90° C., and then heated at 5° C./min to between-35and −30° C. (depending on sample composition) and held for 30 min to anneal. The temperature was then reduced to −90° C. at 10° C./min and held for 10 min. The temperature was then ramped at 1° C./min to 5° C. during which the measurements were made. Duplicate runs were made and results were averaged. The temperature of annealing varied by sample and was determined by a preliminary run during which the approximate onset of melting was determined and used for the annealing temperature.

The midpoint glass transition temperature, onset of melting, and freezing point were calculated from the melting curve generated by the calorimeter. Freezing points were calculated from the DSC freezing curves using the TA Universal Analysis software. The minimum of the endothermic curve during heating of the annealed sample was taken as the freezing point. The glass transition was determined by constructing tangents to the DSC curve baselines before and after the glass transition. The intersection of these tangents to the tangent at the inflection point gives the extrapolated onset, midpoint and endpoint temperatures. The onset of melting was determined by drawing a tangent to the DSC baseline after a steep change on the slope on the curve was detected, which is generally found right after the glass transition.

TABLE 1

| | Freezing | | Onset of | | Total | | % Skim |
|---|---|---|---|---|---|---|---|
| | point | | melting | | solids | % % | milk |
| Formulation | ° C. | ° F. | ° C. | ° F. | (%) | disaccharide | powder |
| A | −0.9 | 30.4 | −23.5 | −10 | 35 | 8.2 | 8.2 |
| B | −1.0 | 30.2 | −25.9 | −15 | 35 | 10.2 | 4.5 |
| C | −1.5 | 29.3 | −34.6 | −30 | 30 | 13.2 | 13.0 |
| D | −2.4 | 27.7 | −35.8 | −32 | 37 | 21.6 | 4.8 |

The data demonstrate that Formulations A and B having lower amounts of disaccharides have higher freezing points and begin melting at higher temperatures, two indicia of storage stability and ability to maintain free-flowing particles. Formulation C, having a lower percentage of disaccharides has a higher freezing point and higher onset of melting than Formulation D. It has been found, however, that Formulation C exhibits even greater storage stability as compared to Formulation D than what would be predicted by freezing point and onset of melting alone. It is postulated that this “better than predicted” behavior is attributable to Formulation C having a much lower percentage of its water in liquid form at 0° F. (−18° C.) than Formulation D. This is supported by comparing the area under the curves for each formulation from the onset of melting up to 0° F. (−18° C.), because the area under the curve indicates how much energy has gone into melting ice and is therefore directly proportional to the amount of ice that has melted to form liquid water. Using this same technique, one would also expect Formulation B to have even less liquid water present at 0° F. than Formulation C, and for Formulation A to have the least amount of liquid water of the formulations tested and for these formulations to exhibit even greater stability and remain free flowing for longer periods of time and/or at higher temperatures.

One must remember, however, that although storage stability is an important property, the product should also have a superior taste to be commercially successful. Accordingly it may be necessary or desirable to sacrifice a certain amount of storage stability for taste to make a desirable product.

It should be noted that the formulations above were not homogenized or pasteurized prior to testing. It is believed that homogenization and/or pasteurization would have little or no effect on the testing results. Also, one may add an artificial sweetener to the formulations above, including formulations A, B, C and E. If artificial sweetener is added, it is included at preferably at 0.01-0.02% by weight, including 0.015% by weight of the total formulation. Preferred artificial sweeteners include sucralose.

### D. Preferred Apparatus and Methods of Manufacture

The product described above may be manufactured in any suitable apparatus and using any suitable method. Accordingly, the methods and apparatus described in this section are merely examples. In a preferred embodiment, a particulate ice cream is manufactured in a process 100 as shown in FIG. 1. The liquid and dry ingredients are separately combined (steps 104, 108), and then the dry materials are injected into the liquid materials (step 112). From that point onward until the dripping step, the formulation is preferably continually agitated (step 116) except for when it is inside the pasteurizer/homogenizer (step 124). The formulation is then stored in an ageing vat (step 128).

Referring to FIG. 2A, one preferred formulation can result in products which are kept at −40° F. for periods of up to two years, although the storage time prior to consumption is usually much shorter. For other formulations, for example, the products are preferably stored at about −30° F. or below for long time storage, and about −20° F. for warehouse distribution. The products made from certain preferred formulations discussed herein remain free-flowing, as defined hereinabove, when stored in a freezer at 0° F. for at least 10 days, at least 20 days, at least 30 days, at least 40 days, or longer. Storage in a freezer at 0° F. includes storage in an automatically defrosting freezer at 0° F. inclusive of a defrosting cycle that includes periodic rises in temperature to about 5° F. for defrosting, for example, about three times each 24 hour period. For such embodiments, the performance of the product is enhanced when the temperature thresholds of the various storage mechanisms shown within FIG. 2A are complied with. Temperatures above these thresholds could result in heat shock, devitrification, and other unwanted effects that would cause the particulate shapes to have a higher stickiness and result in a loss of some or all of the free-flowing character.

FIGS. 2B and 2C address the issue of the products being transported across international borders, therefore requiring inspection. FIG. 2B illustrates a situation in which the product arrives at the border inspection station in a refrigerated delivery truck. Because it is beneficial to avoid subjecting the various products to heat shock, careful precautions are suitable. One such precaution includes a way-station as shown in FIG. 2C, which super-freezes the product such that it can withstand the minimal amount of heat-shock that is an unavoidable part of an inspection process, and yet not enter into a glass-transition phase. In FIG. 2C a specific way-station is shown, which may or may not be separate from a warehouse/distribution location. In FIG. 2C, a warehouse/distribution location and way station is shown being located as close as possible to a customs/border inspector, so that the beneficial super-freezing effect during storage within the warehouse/distribution way station can assist in overcoming the heat-shock that is associated with the inspection process.

Although not shown in FIGS. 2A-2C, another way of building in more resistance to heat shock would be to have the various products placed directly into their retail containers at the manufacturing site. This has the advantage of increased resistivity to heat shock, as the retail containers would provide an insulating effect. Alternatively, the products could be packaged in larger shipping containers and then loaded into their retail containers at a location in the same country as the retail environment where the product will be sold. As stated, gas- or moisture-barrier plastics may be suitable for this purpose.

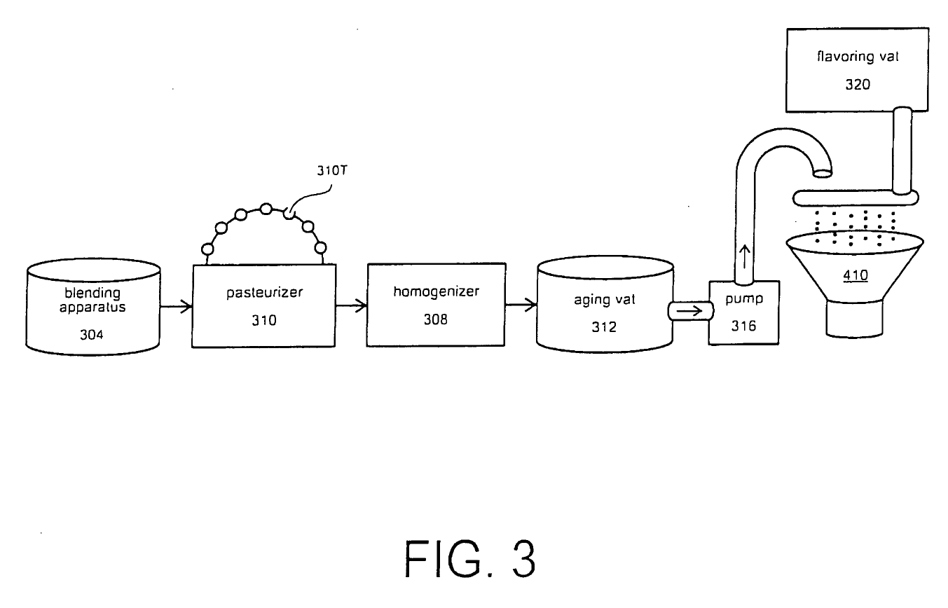

As shown in FIG. 3, a blending apparatus 304 feeds the initial product to a homogenizer 308 that may be used to act as a “timing pump” for the pasteurizer 310, which regulates the speed of the product flowing through the pasteurizer. In some embodiments, the homogenizer 308 is sealed by a government health inspector, and cannot be changed without an inspector present.

The homogenizer 308 and pasteurizer 310 work together as a unit in high temperature short time processes. As shown in FIGS. 1 and 3, the mix is preferably agitated (step 116) right up to the point of pasteurization (step 124), and is then slowly agitated in an aging vat 312 and/or other storage tanks, until being delivered to the cryogenic processor 410. A flavoring vat 320 may optionally be provided to add one or more flavors to the product before it is delivered to the cryogenic processor 410.

Another consideration for production in or for sale in the U.S. is that USDA Pasteurized Milk Ordinances stipulate specific pasteurization temperatures. To address this, as shown in FIG. 3, the length of the holding tubes 310t attached to the pasteurizer 310 determines how long the product will be held at a specific temperature. Different temperatures require different lengths of hold times, and may vary by plant but the minimum temperature and hold time are achieved in preferred embodiments. For 10% butterfat ice cream, in one embodiment the minimum temperature and time is 166° F. for 15 seconds. An 8% fat product needs only to be pasteurized at 161° F. for 15 seconds in one embodiment. For temperatures below 161° F., the minimum is 145° F. for 30 minutes, according to one embodiment. Temperatures and times required may vary by jurisdiction.

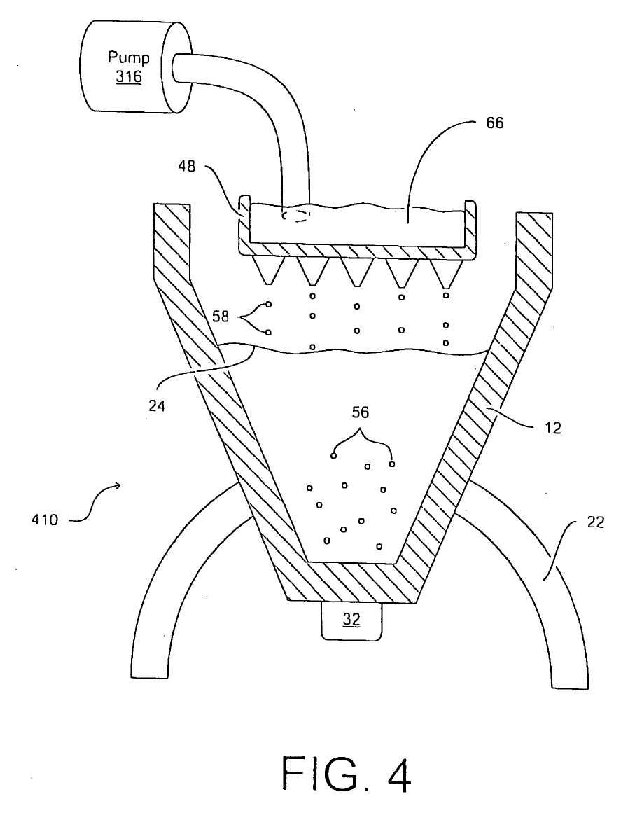

FIG. 4 shows a cross-sectional view of a cryogenic processor 410 constructed in accordance with a preferred embodiment that produces free-flowing particulate shapes 56. The cryogenic processor 410 includes a freezing chamber 12 that is preferably in the form of a conical tank that holds a liquid refrigerant therein. In one embodiment, the freezing chamber 12 is a free-standing unit supported by legs 22.

Refrigerant 24, preferably liquid nitrogen or other cryogenic fluid, is supplied to the freezing chamber 12. A feed tray 48 receives the liquid formulation 66 from a pump 316. The frozen product takes the form of particulate shapes 56 that are formed when droplets 58 of liquid formulation 66 contact the refrigerant vapor and subsequently the liquid refrigerant 24 in the freezing chamber 12. After the particulate shapes 56 are formed, they fall to the bottom of chamber 12. A transport system connects to the bottom of chamber 12 at outlet 32 to auger or carry the particulate shapes 56 to the next part of the process, which may be a package for bulk storage or packaging such as for distribution and/or sale. After having reached the outlet 32, the particulate shapes 56 are free-flowing and do not stick together.

The temperature of the formulation 66 can be maintained at a wide range of temperatures just prior to being dripped into the processor 410 (FIGS. 3, 4). Lower temperatures, preferably around +40° F. or below are preferred so as to promote rapid freezing. The temperature of the formulation 66 preferably does not fall below about 28° F. prior to being dripped so that it does not become too solid to flow well. Higher temperatures will also affect the amount of refrigerant used to freeze the product. A colder mix of formulation 66 uses less refrigerant 24 than a warmer mix, but the particulate shapes 56 of the end product are not substantially affected. In the U.S., the formulation is normally held at about +40° F. due to various Pasteurized Milk Ordinances for minimum temperature storage requirements. These temperatures are often recorded and monitored by USDA inspectors.

As mentioned briefly above, FIG. 9 depicts an example of a serving portion 901 of a product incorporating the particulate shapes described herein. As shown, a bowl or other, similar container is shown that is filled with the particulate shapes. One of ordinary skill will readily recognize that other containers in addition to bowls may be used without departing from the scope of the disclosure herein. Unlike the generally spherical particulate shapes of FIG. 9, FIG. 10 illustrates additional particulate shapes that are presently contemplated. In addition to the spheroid shape 1001, other particulate shapes include smaller spheroids 1003, 1005, clump-like shapes 1007, as well as elliptical or oblong particulate shapes 1009. Thus, when the particulate shapes 1001-1009 of FIG. 10 are served as a product, a serving may resemble the product 1101 of FIG. 11. Again, one of ordinary skill will readily recognize that other containers in addition to the bowl of FIG. 11 may be used without departing from the scope of the present disclosure.

The various aspects have been described in detail with particular reference to preferred embodiments, but it will be understood that variations and modifications can be effected within the spirit and scope of the disclosed inventions as described herein. It is anticipated that various changes may be made in the arrangement and operation of the system and formulations without departing from the spirit and scope thereof.

What is claimed is:

1. A frozen food product, comprising:
water and total solids, wherein the product comprises:
6-14% by weight milk fat;
4-24% by weight non-fat milk solids;
2.6-8% by weight sugar; and
0-0.4% by weight sweetener;
and wherein the product is in the form of particulate shapes which remain free-flowing when stored in a freezer at 0° F. for at least 20 days.

2. The frozen food product of claim 1, wherein the product comprises:
8-12% by weight milk fat;
13-24% by weight non-fat milk solids; and
2.6-5% by weight sugar;

3. The frozen food product of claim 1, wherein the product comprises 8.4% milkfat, 18.2% non-fat milk solids, 3% sucrose, and 0.02% sweetener.

4. The frozen food product of claim 1, wherein the product comprises at least about 29% by weight total solids and less than about 71% by weight water.

5. The frozen food product of claim 1, wherein the sweetener comprises sucralose.

6. The frozen food product of claim 1, wherein the product remains free flowing for at least 30 days.

7. The frozen food product of claim 1, further comprising 0.1-1% by weight of cryoprotectant.

8. The frozen food product of claim 1, further comprising one or more natural and/or artificial flavors.

9. The frozen food product of claim 1, further comprising 1-4% combined stabilizer/emulsifier.

10. The frozen food product of claim 1, wherein the nonfat milk solids comprise egg yolk.

11. The frozen food product of claim 1, wherein the sweetener further comprises corn syrup solids and cocoa powder.

12. The frozen food product of claim 1, wherein the formulation has a glass transition temperature of at least −53° F.

13. A frozen food product, comprising:
water and total solids, wherein the total solids comprises:
6-14% by weight milk fat;
4-24% by weight non-fat milk solids;
2.6-5% by weight sugar;
0-0.4% by weight sweetener; and
1-20% by weight bulking agent;
and wherein the formulation is in the form of particulate shapes which remain free-flowing when stored in a freezer at 0° F. for at least 20 days.

14. The frozen food product of claim 13, wherein the product comprises at least about 29% by weight total solids and less than about 71% by weight water.

15. The frozen food product of claim 13, wherein the sweetener comprises sucralose.

16. The frozen food product of claim 13, wherein the product remains free flowing for at least 30 days.

17. The frozen food product of claim 13, further comprising 0.1-1% by weight of cryoprotectant.

18. The frozen food product of claim 13, further comprising one or more natural and/or artificial flavors.

19. The frozen food product of claim 13, wherein the nonfat milk solids comprise modified whey products and dry whey solids.

20. The frozen food product of claim 13, wherein the nonfat milk solids comprise egg yolk.

21. The frozen food product of claim 13, wherein the sweetener further comprises corn syrup solids and cocoa powder.

22. The frozen food product of claim 13, wherein the bulking agent comprises maltodextrins.

23. The frozen food product of claim 13, wherein the formulation has a glass transition temperature of at least −45° F., and a devitrification temperature of −44° F.

24. A method of manufacturing a frozen food product, comprising:
preparing a formulation according to claim 1 or 13 comprising
combining liquid ingredients;
combining dry powders; and
mixing the combined dry powders with the combined liquids to make the formulation;
agitating the formulation;
pasteurizing the formulation;
homogenizing the formulation;
aging the formulation; and
dripping the formulation into a cryogenic processor to form a particulate frozen food product, wherein the particulate frozen food product includes both spheroid and non-spheroid particulates.

25. The method of claim 24, wherein the homogenizing step acts to synchronize the pasteurizing step.

26. A method of retailing a frozen product, comprising:
manufacturing a particulate frozen product by combining at least the following:
6-20% by weight milk fat;
4-16% by weight non-fat milk solids;
0-19% by weight maltodextrins and/or other bulking agents;
2.6-8% by weight sugar;
0-0.4% by weight sweetener; and
0-4% by weight combined stabilizer and emulsifier; and
shipping the particulate frozen product to a plurality of staging areas;
during the shipping step, maintaining the particulate frozen product at a predetermined temperature range; thereby preserving the free-flowing nature of the particulate frozen product;
staging the particulate frozen product in strategic storage locations;
crossing the particulate frozen product over an international border;
shipping the particulate frozen product to a plurality of retail areas; and
retailing the particulate frozen product, wherein the particulate frozen food product includes both spheroid and non-spheroid particulates.

27. The method of claim 14, further comprising:
packaging the particulate frozen product, using gas- or moisture-barrier plastics.

28. A frozen food product, comprising:
water and total solids, wherein the product comprises:
2-10% by weight sugar;
0.1-1.0% by weight sweetener; and
0-2% by weight stabilizer.
